(19) United States
(12) Patent Application Publication
(10) Pub. No.: US 2009/0086998 A1
(43) Pub. Date: Apr. 2, 2009

(54) Method and apparatus for identifying sound sources from mixed sound signal

(75) Inventors: So-young Jeong, Seoul (KR); Kwang-cheol Oh, Yongin-si (KR); Jae-hoon Jeong, Yongin-si (KR); Kyu-hong Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/073,458

(22) Filed: Mar. 5, 2008

(30) Foreign Application Priority Data
Oct. 1, 2007 (KR) 10-2007-0098890

(51) Int. Cl. H04B 1/00

(52) U.S. Cl. 381/119

(57) ABSTRACT

A method and apparatus for discriminating sound sources from a mixed sound is provided. The method includes separating sound source signals from a mixed sound signal including a plurality of sound source signals that are input through a microphone array, estimating a transfer function of a mixing channel mixing the plurality of sound source signals from relationships between the mixed sound signal and the separated sound source signals, obtaining input signals of the microphone array by multiplying the estimated transfer function by the separated sound source signals, and calculating location information of each sound source using a predetermined sound source location estimation method based on the obtained input signals.

### CROSS-REFERENCE TO RELATED APPLICATIONS

This application claims the priority of Korean Patent Application No. 10-2007-0098890, filed on Oct. 1, 2007, in the Korean Intellectual Property Office, the disclosure of which is incorporated herein in its entirety by reference.

### BACKGROUND

1. Field

One or more embodiments of the present invention relate to a method and apparatus for identifying sound sources from a mixed sound signal, and more particularly, to a method and apparatus for separating independent sound signals from a mixed sound signal containing various sound source signals which are input to a portable digital device that can process or record voice signals, such as a cellular phone, a camcorder or a digital recorder, and for processing a sound signal desired by a user from among the separated sound signals.

2. Description of the Related Art

It has become commonplace to make or receive phone calls, record external sounds, and capture moving images using portable digital devices. Recording sounds or receiving sound signals using portable digital devices is often performed in places having various types of noise and ambient interference rather than in quiet places lacking ambient interference. Technologies for separating sound source signals from mixed sounds and extracting a specific sound source signal required by a user and techniques for removing unnecessary ambient interference sounds from the separated sound source signals have been suggested.

Conventional techniques have been used to separate mixed sounds and identify voice and noise only. Typically, a conventional mixed sound separating technique can separate sound source signals. However, since it is difficult to exactly identify the separated sound source signals, it is difficult to precisely separate sound source signals from a mixed sound signal containing a plurality of sound source signals and to utilize the separated sound source signals.

### SUMMARY

One or more embodiments of the present invention provide a method and apparatus for identifying sound source signals in order to mitigate a problem of failing to exactly identify individual sound signals separated from a mixed sound signal containing signals from a plurality of sound source signals, and for overcoming a technical limitation that each separated sound signal is not properly utilized and is used to merely extract a voice signal and noise therefrom.

One or more embodiments of the present invention also provide a method and apparatus for overcoming a technical limitation where each separated sound signal is not properly utilized and is used to merely extract a voice signal and noise therefrom.

Additional aspects and/or advantages will be set forth in part in the description which follows and, in part, will be apparent from the description, or may be learned by practice of the invention.

According to an aspect of the present invention, a method of discriminating sound sources is provided. The method includes separating sound source signals from a mixed sound signal including a plurality of sound source signals that are input through a microphone array, estimating a transfer function of a mixing channel mixing the plurality of sound source signals from relationships between the mixed sound signal and the separated sound source signals, obtaining input signals of the microphone array by multiplying the estimated transfer function by the separated sound source signals, and calculating location information of each sound source by using a predetermined sound source location estimation method based on the obtained input signals.

According to another aspect of the present invention, a computer-readable recording medium is provided, on which a program for executing the method of discriminating sound sources is recorded.

According to another aspect of the present invention, an apparatus for discriminating sound sources is provided. The apparatus includes a sound source separation unit separating sound source signals from a mixed sound signal including a plurality of sound source signals that are input through a microphone array, a transfer function estimation unit estimating a transfer function of a mixing channel mixing the plurality of sound source signals from relationships between the mixed sound signal and the separated sound source signals, an input signal obtaining unit obtaining input signals of the microphone array by multiplying the estimated transfer function by the separated sound source signals, and a location information calculation unit calculating location information of each sound source by using a predetermined sound source location estimation method based on the obtained input signals.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a problematic situation that one or more embodiments of the present invention address;

FIG. 2 illustrates an apparatus for discriminating sound source signals from a mixed sound signal, according to embodiments of the present invention;

FIG. 3 illustrates the apparatus for discriminating sound source signals from a mixed sound signal of FIG. 2, according to an embodiment of the present invention;

FIG. 4A illustrates a permutation ambiguity that occurs when a sound source signal discriminating apparatus separates independent sound source signals from a mixed sound signal, according to an embodiment of the present invention;

FIG. 4B illustrates a solution of a permutation and scaling ambiguity used to estimate an input signal from independent sound source signals in a sound source signal discriminating apparatus, according to an embodiment of the present invention; and

FIG. 5 illustrates a method of discriminating sound source signals from a mixed sound signal, according to an embodiment of the present invention.

### DETAILED DESCRIPTION OF EMBODIMENTS

Reference will now be made in detail to embodiments, examples of which are illustrated in the accompanying drawings, wherein like reference numerals refer to the like elements throughout. Embodiments are described below to explain the present invention by referring to the figures.

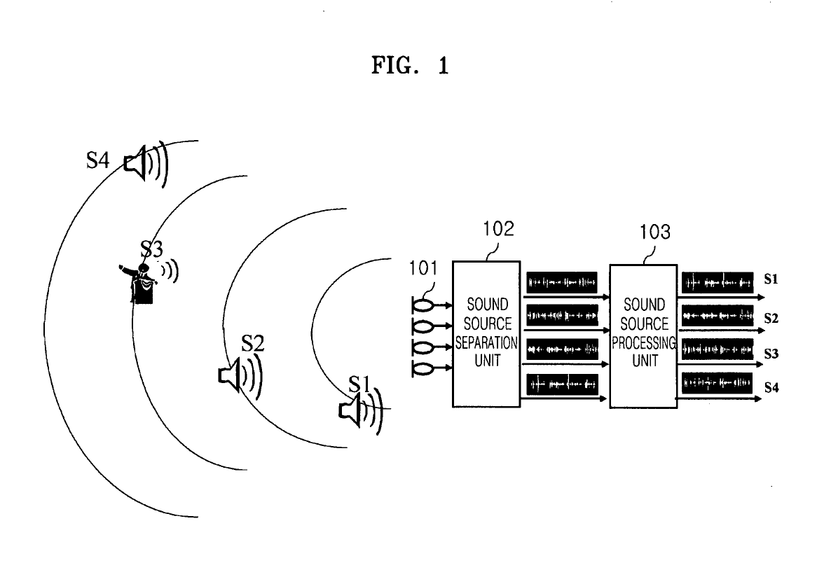

FIG. 1 illustrates a problematic situation addressed by one or more embodiments of the present invention. In FIG. 1, it is assumed that four sound sources S1 through S4 are located different distances from a microphone array 101. Further, it is assumed that each of these four sound sources S1 through S4 have a different environment in which various elements are configured to characterize a sound source, such as a distance from the microphone array 101, an angle of each sound source with regard to the microphone array 101, a type thereof, a property thereof, and volume thereof and the like. This is to approximate the mixed sound environment that typical in a user's everyday life.

An apparatus for obtaining a sound source signal under the above assumption may include, for example, a microphone array 101, a sound source separation unit 102, and a sound source processing unit 103. Although the microphone array 101, which is an input unit receiving the four sound sources S1 through S4, may be substituted as a single microphone, it may also be realized as a plurality of microphones so as to collect many pieces of information from each of the sound sources S1 through S4 and easily process the collected sound source signals.

The sound source separation unit 102, which is a device separating a mixed sound input through the microphone array 101, separates the four sound sources S1 through S4 from the mixed sound. The sound source processing unit 103 enhances sound quality of the separated sound sources S1 through S4, or increases a gain thereof.

A separation of original sound source signals from a mixed signal having a plurality of sound source signals is referred to as blind source separation (BSS). That is, the BSS aims to separate each sound source from a mixed sound signal without prior information regarding the signal sound source. One technique used to perform the BSS is independent component analysis (ICA) performed by the sound source separation unit 102. The ICA is used to find signals before being mixed and mixed matrices under the circumstances that a plurality of mixed sound signals are collected through a microphone and original signals are statistically independent from the collected sound signals. Statistical independence signifies that individual signals constituting a mixed signal do not provide any information regarding other corresponding signals. In other words, a sound source separation technology using the ICA can output sound source signals that are statistically independent from each other while providing no information on original sound source signals of the separated sound source signals.

Thus, in order to process and utilize sound sources separated by the sound source separation unit 102, a process for additionally extracting sound source information such as a direction and distance of a sound source, performed by the sound source processing unit 103, is needed. The sound source processing is used to discriminate microphone array input signals, e.g., to discriminate separate sound sources input into the microphone array 101 from initial sound source signals. Hereinafter, the above described problematic situation and the approach of the present invention is described in more detail based on the sound source processing unit 103 used to solve the problematic situation.

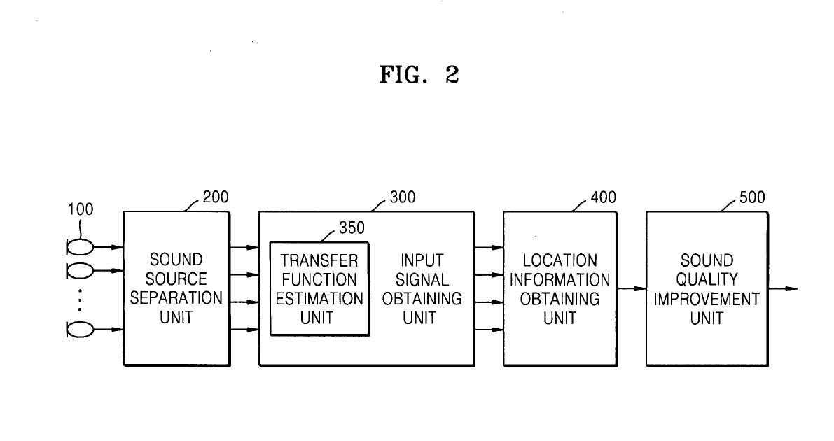

FIG. 2 illustrates an apparatus for discriminating sound source signals from a mixed sound signal, according to embodiments of the present invention. Referring to FIG. 2, the apparatus for discriminating sound source signals from the mixed sound signal may include, for example, a microphone array 100, a sound source separation unit 200, an input signal obtaining unit 300, a location information obtaining unit 400, and a sound quality improvement unit 500.

The sound source separation unit 200 separates independent sound sources from a mixed sound input through the microphone array 100 using various ICA algorithms. As would be understood by one of ordinary skill in the art, examples of these ICA algorithms include infomax, FastICA, JADE and the like. Although the sound source separation unit 200 separates the mixed sound into independent sound sources having statistically different properties, it is not notified of specific information regarding which direction each independent sound source signal is located, how far each independent sound source signal is from it, whether each independent sound source signal is noise or not, etc., before being input into the microphone array 100 as the mixed sound signal. Therefore, in order to precisely estimate additional information regarding a direction, distance, and the like of each separate independent sound source signal, it is more important to obtain an input signal of a microphone array with regard to each sound source, rather than conventionally discriminate voice and noise.

The input signal obtaining unit 300 obtains input signals of the microphone array 100 with regard to each independent sound source that is separated by the sound source separation unit 200. A transfer function estimation unit 350 estimates a transfer function with regard to a mixed channel when a plurality of sound sources are input into the microphone array 100 as a mixed signal. The transfer function of the mixed channel refers to an input and output ratio used to mix the plurality of sound sources as the mixed signal. In a narrow sense, the transfer function of the mixed channel refers to a ratio of signals obtained by converting the plurality of sound source signals and the mixed signal using a Fourier transform function. In a broad sense, the transfer function of the mixed channel refers to a function indicating signal transfer characteristics of the mixed channel, from an input signal to an output signal. A process of estimating the transfer function of the mixed channel will now be described in more detail.

The sound source separation unit 200 determines an unmixing channel regarding the relationship between the mixed signal and the separated sound source signals by performing a statistical sound source separation process using a learning rule of the ICA. The unmixing channel has an inverse correlation with the transfer function that is to be estimated by the transfer function estimation unit 350. Thus, the transfer function estimation unit 350 can estimate the transfer function by obtaining an inverse of the unmixing channel. The input signal obtaining unit 300 multiplies the estimated transfer function by the separated sound source signals to obtain the input signals of the microphone array 100.

The location information obtaining unit 400 precisely estimates location information for each sound source, without ambient interference sound. The location information is estimated with regard to the input signals of the microphone array 100 obtained by the input signal obtaining unit 300, in a state where no ambient interference sound is generated. The state where no ambient interference sound is generated refers to an environment in which each sound only exists in isolation, without interference between sound sources. That is, each input signal obtained by the input signal obtaining unit 300 includes a signal from only one sound source. The location information obtaining unit 400 obtains the location information of each sound source using various sound source location estimation methods such as a time delay of arrival (TDOA), beam-forming, spectral analysis and the like, in order to estimate location information with respect to each input signal, as will be understood by those of ordinary skill in the art. A location information estimation method will now be briefly described.

The location information obtaining unit 400 pairs microphones constituting an array with regard to a signal that is input to the microphone array 100 from a sound source, measures a time delay between the paired microphones, and estimates a direction of the sound source from the measured time delay. The location information obtaining unit 400 uses the TDOA to determine that the sound source exists at a point in space where directions of sound sources estimated from each paired microphones cross each other. Alternatively, the location information obtaining unit 400 uses beam-forming to delay a sound source signal at a specific angle, to scan signals in space according to the angle, to select a location having a greatest signal value from among the scanned signals, and to estimate a location of the sound source.

The location information, such as a direction and distance of one sound source signal, described above, can be used to more accurately and easily process a signal, compared to location information obtained from a mixed sound. In addition, one or more embodiments of the present invention provide a method and apparatus for processing a specific sound source based on the location information obtained by the location information obtaining unit 400. In this regard, the sound quality improvement unit 500 uses the location information to improve a signal to noise ratio (SNR) of a specific sound source from among the sound sources and thereby improves sound quality. The SNR refers to a value expressed by a ratio that indicates the amount of noise included in a signal.

Since the location information obtaining unit 400 obtains various pieces of location information including the direction and distance of each sound source, the sound quality improvement unit 500 arranges the sound source signals according to directions and distances thereof in order to select a specific sound source signal with regard to a sound source located at a distance or in a direction desired by a user. Furthermore, a SNR of each separated independent sound source is improved through a spatial filter, such as beam-forming, with regard to the selected specific sound source so as to apply various processing methods of improving sound quality or amplifying sound volume. For example, a specific spatial frequency component included in the separated independent sound sources can be emphasized or attenuated through a filter. In order to improve the SNR, the user must emphasize a desired signal and attenuate a signal that is regarded as noise with the filter.

A general microphone array including two or more microphones enhances amplitude by properly giving a weight to each signal received by the microphone array so as to receive a target signal including background noises at high sensitivity. Thus, if the desired target signal and a noise signal have a different direction, the general microphone array serves as a filter for spatially reducing noise. This type of spatial filter is referred to as beam-forming. Therefore, the user can improve sound quality of a specific sound source desired by the user from among the separated independent sound sources through the sound quality improvement unit 500 using beam-forming. It will be understood by those of ordinary skill in the art that the sound quality improvement unit 500 can be selectively applied, and a sound source signal processing method using various beam-forming algorithms can be additionally applied instead of the sound quality improvement unit 500.

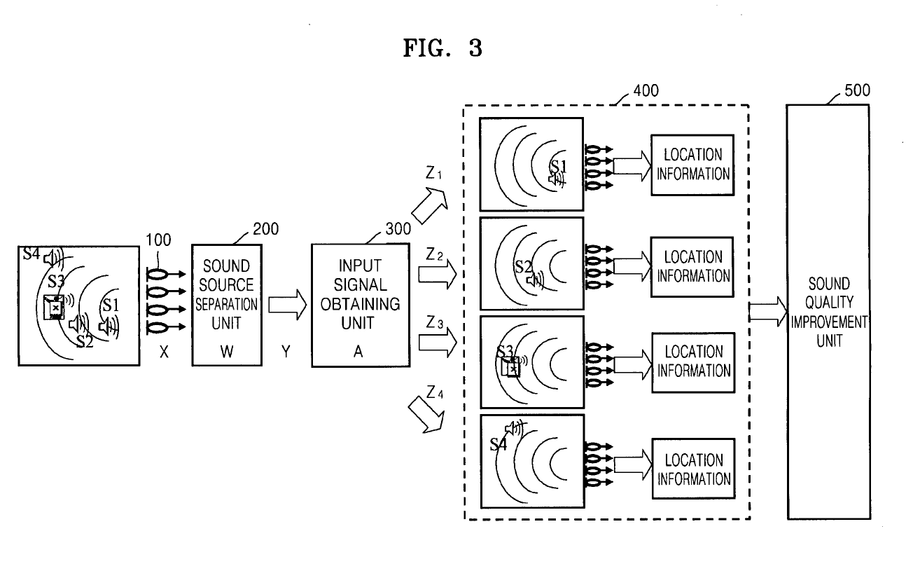

FIG. 3 illustrates the apparatus for discriminating sound source signals from a mixed sound signal of FIG. 2, according to an embodiment of the present invention. Similar to the apparatus shown in FIG. 2, referring to FIG. 3, the apparatus for discriminating the sound signal from the mixed sound signal may include, for example, a microphone array 100, a sound source separation unit 200, an input signal obtaining unit 300, a location information obtaining unit 400, and a sound quality improvement unit 500. The mixed sound includes four sound sources S1 through S4.

The microphone array 100 receives the mixed sound as a ratio of four independent sound sources that are input into four microphones. If S denotes the four sound sources S1 through S4, and X denotes a mixed sound signal input into the microphone array 100, the relationship between S and X is expressed according to Equation 1 below:

$$X = AS \\ [ \begin{matrix}{X}_{1} \\ {X}_{2} \\ {X}_{3} \\ {X}_{4}\end{matrix} ] = [ \begin{matrix}{A}_{11} & {A}_{12} & {A}_{13} & {A}_{14} \\ {A}_{21} & {A}_{22} & {A}_{23} & {A}_{24} \\ {A}_{31} & {A}_{32} & {A}_{33} & {A}_{34} \\ {A}_{41} & {A}_{42} & {A}_{43} & {A}_{44}\end{matrix} ] [ \begin{matrix}{S}_{1} \\ {S}_{2} \\ {S}_{3} \\ {S}_{4}\end{matrix} ] \qquad Equation 1$$

A or Aᵢⱼ denotes a mixing channel or a mixing matrix of sound source signals. i denotes an index of sensors (four microphones). j denotes an index of sound sources. That is, Equation 1 expresses the mixed sound signal X that is input into four microphones constituting the microphone array 100 through the mixing channel from four sound sources.

Each sound source signal forming the mixed signal is initially an unknown value. Thus, it is necessary to establish the number of input signals according to a target object and an environment where the mixed signal is input. Although four input signals are established in the present embodiment, four external sound source signals are, in reality, quite rare. If the number of external sound source signals is greater than a previously established number of input signals, one or more sound sources may be included in some of four independent sound sources. Therefore, it is necessary to establish the index j of a proper number of sound sources in order to prevent noise or other unnecessary signals having a very small sound pressure compared to the size and environment of a target signal from being separated from an independent sound source.

The sound source separation unit 200 separates the mixed sound signal X, including statistically different and independent four sound sources S1 through S4, into independent sound sources Y using an ICA separation algorithm. The BSS separates each sound source from a mixed sound signal without prior information regarding the sound source of the signal, as described with reference to FIG. 1. The BSS aims to estimate the initial sound sources S and the mixing channel A when the mixed sound signal X that is input through the microphone array 100 is known. Thus, in order to separate the independent sound sources Y, the sound source separation unit 200 finds an unmixing channel W for making elements of the mixed sound signal X statistically independent from each other. The sound source separation unit 200 determines the unmixing channel W for separating the mixing channel A through which original sound source signals are input as a mixed sound using the ICA. In more detail, the sound source separation unit 200 determines that an unknown unmixing channel W to update the separated independent sound sources Y is approximately similar to the initial sound sources S. The method of determining an unknown channel using the ICA is generally known in the art as demonstrated by (T. W. Lee, Independent component analysis—theory and applications, Kluwer, 1998).

The relationship between the mixed sound signal X and the separated independent sound sources Y is expressed according to Equation 2 below.

$$Y = WX \\ [ \begin{matrix}{Y}_{1} \\ {Y}_{2} \\ {Y}_{3} \\ {Y}_{4}\end{matrix} ] = [ \begin{matrix}{W}_{11} & {W}_{12} & {W}_{13} & {W}_{14} \\ {W}_{21} & {W}_{22} & {W}_{23} & {W}_{24} \\ {W}_{31} & {W}_{32} & {W}_{33} & {W}_{34} \\ {W}_{41} & {W}_{42} & {W}_{43} & {W}_{44}\end{matrix} ] [ \begin{matrix}{X}_{1} \\ {X}_{2} \\ {X}_{3} \\ {X}_{4}\end{matrix} ] \qquad Equation 2$$

In Equation 2, W denotes an unmixing channel or an unmixing matrix having an unknown value. In Equation 2, the unmixing channel W can be obtained from elements X1 through X4 of the mixed sound signal X, which is measured as an input value through the microphone array 100 using a learning rule of the ICA.

The input signal obtaining unit 300 estimates a transfer function of the separated independent sound sources Y to obtain the input signals of the microphone array 100, and includes a transfer function estimation unit (not shown). The transfer function estimation unit (not shown) obtains an inverse of the unmixing channel W for separating independent sound sources from the separated independent sound sources Y from the sound source separation unit 200 in order to estimate the transfer function of the separated independent sound sources Y Since the transfer function concerns the unmixing channel A, if the unmixing channel W that is contrary to the unmixing channel A is determined, the inverse of the unmixing channel W is obtained and the transfer function of the unmixing channel A is estimated. The input signal obtaining unit 300 multiplies the estimated transfer function by the separated independent sound sources Y and generates signals Z1 through Z4 corresponding to the input signals when the independent sound sources S1 through S4 are input into the microphone array 100.

The signals Z1 through Z4 that are input into the microphone array 100 with regard to one sound source differ from the mixed sound signal X that is initially input into the microphone array 100. For example, the mixed sound signal X includes all four sound sources S1 through S4 with reference to FIG. 3, whereas the signal Z1 obtained by the input signal obtaining unit 300 includes a signal of the sound source S1. Thus, the input signals S1 through S4 of the microphone array 100, which are obtained by the input signal obtaining unit 300, do not influence each other but are measured in an environment where only one signal exists, making it possible to precisely extract and utilize location information regarding sound source signals including directions and distances of sound sources.

The relationships between the separated independent sound sources Y that are output by the sound source separation unit 200 and the input signals Z (e.g., Z1 through Z4) that are estimated by the input signal obtaining unit 300 are expressed according to equation 3 below.

W⁻¹≈A

Z=W⁻¹Y=AY Equation 3

W⁻¹ denotes an inverse matrix of the unmixing matrix W of the sound source separation unit 200 and is used to estimate a transfer function A by the transfer function estimation unit (not shown) of the input signal obtaining unit 300. Thus, in Equation 3, the mixing channel A has an inverse correlation with the unmixing matrix W. Furthermore, the transfer function of the mixing channel A that is estimated by the transfer function estimation unit (not shown) is multiplied by the separated independent sound sources Y that are output by the sound source separation unit 200 so that the input signals Z of the microphone array 100 can be estimated.

Elements of the input signals of the microphone array 100 with regard to the sound sources S1 through S4 are expressed using Equation 3 according to Equation 4 below.

$${Z}_{1} = [ \begin{matrix}{Z}_{11} \\ {Z}_{12} \\ {Z}_{13} \\ {Z}_{14}\end{matrix} ] = [ \begin{matrix}{A}_{11} \cdot {Y}_{1} \\ {A}_{21} \cdot {Y}_{1} \\ {A}_{31} \cdot {Y}_{1} \\ {A}_{41} \cdot {Y}_{1}\end{matrix} ] , … , {Z}_{4} = [ \begin{matrix}{Z}_{14} \\ {Z}_{24} \\ {Z}_{34} \\ {Z}_{44}\end{matrix} ] = [ \begin{matrix}{A}_{14} \cdot {Y}_{4} \\ {A}_{24} \cdot {Y}_{4} \\ {A}_{34} \cdot {Y}_{4} \\ {A}_{44} \cdot {Y}_{4}\end{matrix} ] \qquad Equation 4$$

A component of a mixing channel A in equation 4 is identical to a column component of the mixing matrix A in equation 1. For example, Z₁ includes components A₁, A₂₁, A₃₁, and A₄₁ of the mixing channel A, which are first column components of the mixing matrix A in Equation 1. This is because a matrix multiplication operation is performed with regard to each sound source component, in contrast to an initially input mixed sound source. Thus, Z₁ includes first column components A₁₁, A₂₁, A₃₁, and A₄₁ of the mixing matrix A. Likewise, Z₄ includes fourth column components A₁₄, A₂₄, A₃₄, and A₄₄ of the mixing matrix A. Referring to Equations 3 and 4, it is possible to obtain the input signals of the microphone array 100 with regard to the sound sources S1 through S4 by the input signal obtaining unit 300.

The operations of the location information obtaining unit 400 and the sound quality improvement unit 500 have been described above with reference to FIG. 2 and thus their detailed descriptions will not be repeated here.

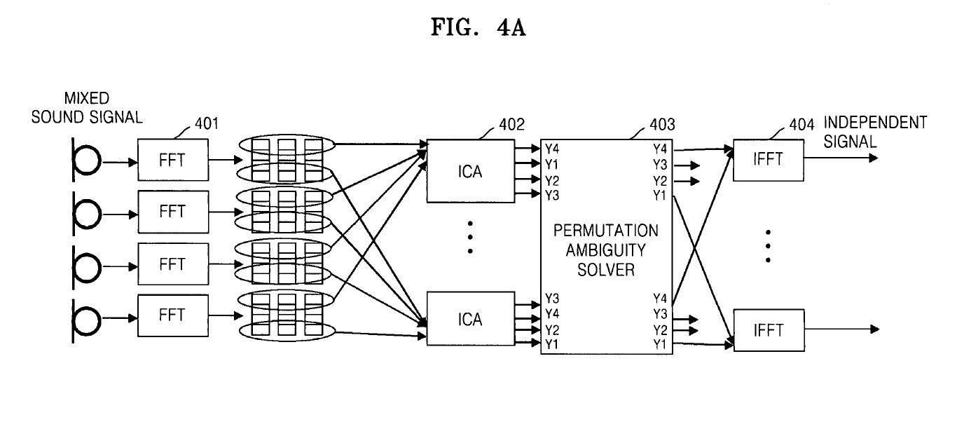

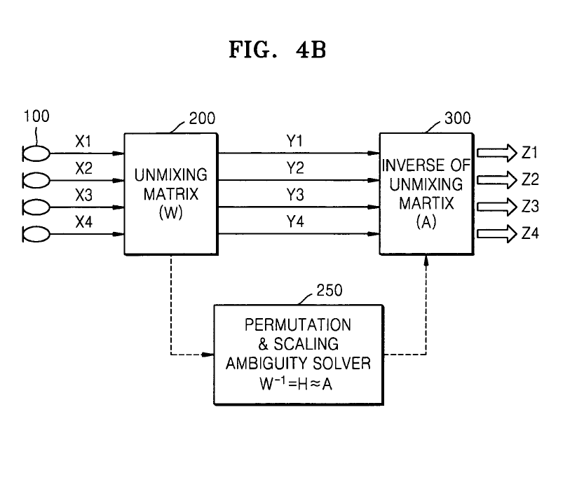

Meanwhile, the sound source separation process, by performing the ICA, uses a frequency domain separation technique in order to more easily handle a signal of a convolution mixing channel. The ICA is performed with regard to frequency bands to extract independent sound source signals. Since an arrangement order of independent sound source signals differs in each frequency band, if inverse fast Fourier transformation (IFFT) is used to transform independent sound source signals into time domain signals, the arrangement order thereof may be reversed. The time domain signals having a reversed order make it impossible to properly extract independent sound source signals. Furthermore, one equation of the multiplication of a transfer function and independent sound source signals can express a multiplication result only, not values of the transfer function and independent sound source signals, resulting in ambiguity and making it impossible to determine each value thereof. For example, in an equation including three values, if there is only one known value, the equation cannot be used to determine the other two unknown values. However, various combinations can be estimated as solutions of the two unknown values, which is referred to as a permutation and scaling ambiguity. This will be now described with reference to FIGS. 4A and 4B.

FIG. 4A illustrates a permutation ambiguity that occurs when a sound source signal discriminating apparatus separates independent sound source signals from a mixed sound signal, according to an embodiment of the present invention. Referring to FIG. 4A, a fast Fourier transform (FFT) 401 is used to transform a mixed sound signal from the time domain into the frequency domain to facilitate signal processing. An ICA 402 is used to separate the mixed sound signal according to frequency band into independent sound source signals. These processes cause the permutation ambiguity. In an order of elements of independent sound source signals separated through the ICA 402, an order of independent sound source signals Y4-Y1-Y2-Y3 above a permutation ambiguity solving unit 403 differs from that of independent sound source signals Y3-Y4-Y2-Y1 below the permutation ambiguity solving unit 403. An order of a sequential combination of independent sound sources differs by frequency band, which makes it impossible to precisely obtain independent sound source signals. Thus, the permutation ambiguity solving unit 403 corrects the arrangement orders of the independent sound source signals Y4-Y1-Y2-Y3 and Y3-Y4-Y2-Y1 that are input values and generates independent sound source signals Y4-Y3-Y2-Y1 as output values. An IFFT 404 is used to transform the independent sound source signals from the frequency domain into the time domain and to finally generate independent signals.

Regarding the permutation and scaling ambiguity with reference to Equation 3 and FIG. 3, even if the transfer function of the mixing channel A approximate to W⁻¹ is estimated by the input signal obtaining unit 300, a value slightly different from the mixing channel A is estimated. Equation 3 is changed using H, which denotes the slightly different value, according to Equation 5 below.

W⁻¹=H=P·D·A Equation 5

P denotes a permutation matrix. D denotes a diagonal matrix. When compared to Equation 3, unintended P and D are added, so that precise independent sound sources are not extracted. In more detail, the permutation matrix P is expressed according to Equation 6 below.

$$P = [ \begin{matrix}0 & 1 & 0 & 0 \\ 1 & 0 & 0 & 0 \\ 0 & 0 & 0 & 1 \\ 0 & 0 & 1 & 0\end{matrix} ] \qquad Equation 6$$

The permutation matrix P is for selecting one element from one row. For example, if an input value including four elements is multiplied by the permutation matrix P, the four elements are extracted one by one, while an order of extracted four elements is reversed compared to an order of an initial input value. That is, the permutation matrix P is used to optionally permute an order of input sound sources. Thus, the multiplication of the permutation matrix P in Equation 5 results in the reverse of the arrangement order of the independent sound sources by each frequency band as described with reference to FIG. 4A.

In order to solve the permutation ambiguity, a technique of correcting the reversed arrangement order of elements of independent sound sources is widely used by extracting a directivity pattern from an estimated unmixing channel of the ICA and arranging row vectors of the unmixing channel according to a nulling point (Hiroshi Sawada, et. al, “A robust and precise method for solving the permutation problems of frequency-domain blind source separation”, IEEE Trans. Speech and Audio Processing, Vol. 12, No. 5, pp. 530-538, September 2004).

The diagonal matrix D is expressed according to Equation 7 below.

$$D = [ \begin{matrix}{α}_{1} & 0 & 0 & 0 \\ 0 & {α}_{2} & 0 & 0 \\ 0 & 0 & {α}_{3} & 0 \\ 0 & 0 & 0 & {α}_{4}\end{matrix} ] \qquad Equation 7$$

The diagonal matrix D has diagonal components having values α₁, α₂, α₃, and α₄ in which a scalar multiplication of each element of input sound sources by α₁, α₂, α₃, and α₄ is output. Thus, the multiplication of the diagonal matrix D is a change of the size of the transfer function of the mixing channel A to a multiplication value by a specific scalar value.

In order to solve a scaling ambiguity, a method of applying diagonal components of the Monroe-Penrose generalized inverse matrix to the estimated unmixing channel W is performed according to Equation 8 below (N. Murata, S. Ikeda, and A. Ziehe, “An approach to blind source separation based on temporal structure of speech signals”, Neurocomputing, Vol. 41, No. 1-4, pp. 1-24, October 2001).

W←diag[W⁺(f)]·W Equation 8
where, W⁺(f) is Moore-Penrose generalized inverse of W(f)

In Equation 8, the Monroe-Penrose generalized inverse matrix solves the scaling ambiguity by normalizing the size of each element to 1. In particular, the Monroe-Penrose generalized inverse matrix can be applied when column and row values differ from each other (i.e., the number of microphones constituting an array differs from the number of sound source signals) while an inverse matrix is generally obtained when column and row values are identical to each other.

Therefore, as described above, the components of the permutation matrix P and the diagonal matrix D in Equation 5 are removed so that the inverse of the unmixing channel W is corrected so as to approximate the transfer function of the mixing channel A in Equation 3.

FIG. 4B illustrates a solution of the permutation and scaling ambiguity used to estimate an input signal from independent sound source signals in a sound source signal discriminating apparatus, according to an embodiment of the present invention. In addition to the sound source separation unit 200 and the input signal obtaining unit 300 described with reference to FIG. 3, a permutation and scaling ambiguity solver 250 will now be described with reference to FIG. 4B.

The permutation and scaling ambiguity solver 250 provides the solution for the permutation of an order of elements of separated independent sound sources and the ambiguity in determination of the size of a transfer function, so that W⁻¹, the reverse of the unmixing channel W, is approximated to the mixing channel A. Although the permutation and scaling ambiguity solver 250 is separated from the sound source separation unit 200 and the input signal obtaining unit 300 for convenience of description, each of the separated sound sources Y1 through Y4 is physically output through the permutation and scaling ambiguity solver 250 in order to properly separate the sound sources Y1 through Y4 that are input into the input signal obtaining unit 300 from the sound source separation unit 200.

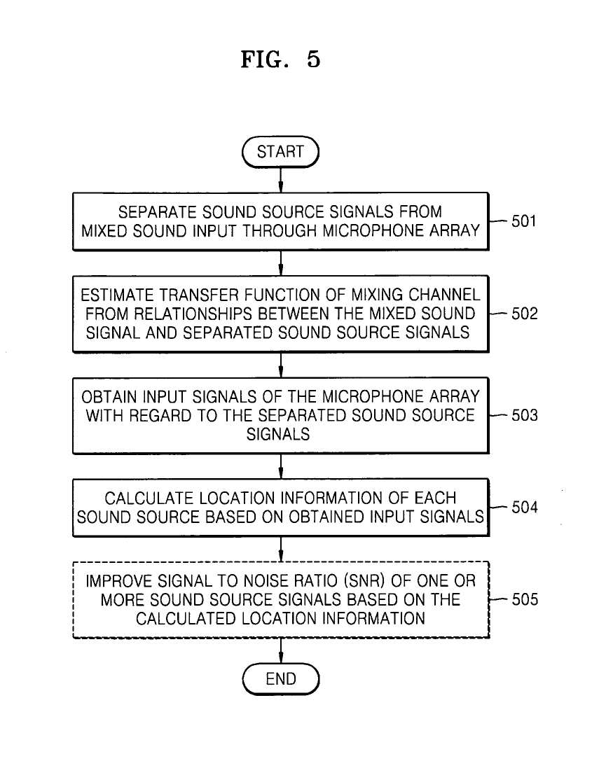

FIG. 5 illustrates a method of discriminating sound source signals from a mixed sound signal, according to an embodiment of the present invention. Referring to FIG. 5, sound source signals are separated from a mixed sound signal that is input through a microphone array (operation 501). This separation operation is performed by the sound source separation unit 200 shown in FIGS. 2 and 3 by performing a statistical sound source separation process using the ICA.

A transfer function of a mixing channel including a plurality of sound sources is estimated from relationships between the mixed sound signal and the separated sound source signals (operation 502). This operation is performed by the transfer function estimation unit 350 shown in FIG. 2 by determining an unmixing channel and obtaining a reverse of the determined unmixing channel using a learning rule of the ICA. This operation causes a permutation and scaling ambiguity, which is solved using a method of arranging column vectors of the unmixing channel and a method of using a diagonal component of a reverse of an unmixing matrix.

Input signals of the microphone array with regard to the separated sound source signals are obtained (operation 503). This operation is performed by the input signal obtaining unit 300 shown in FIGS. 2 and 3, by multiplying the estimated transfer function by the separated sound source signals.

Location information on each sound source is calculated based on the input signals (operation 504). A variety of sound source location estimation methods used in a microphone array signal processing field are used to calculate location information on each sound source such as a direction and distance of each sound source.

Therefore, it is possible to discriminate signals of each sound source, included in the mixed sound. A sound quality improvement technique will now be provided as an additional technique of utilizing discriminated sound source signals.

An SNR of each sound source signal is improved using the location information to enhance sound quality (operation 505). The separated sound source signals are arranged in a specific order according to distance or direction information so as to select specific sound source signals corresponding to sound sources located at distances or in directions desired by a user, or so as to operate specific sound source signals by improving sound quality of or increasing sound volume using various beam-forming algorithms of the microphone array.

According to one or more embodiments of the present invention, an input signal of a microphone array is obtained with respect to each sound source separated from a mixed sound signal containing a plurality of sound sources, thereby exactly identifying each separated sound source signal and outputting location information for each sound source based on the obtained input signal, making it possible to apply various sound quality improvement algorithms for removing noise from a specific sound source signal or for increasing sound quantity, which is used in a microphone array signal processing field.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of discriminating sound sources, the method comprising:
separating sound source signals from a mixed sound signal including a plurality of sound source signals that are input through a microphone array;
estimating a transfer function of a mixing channel mixing the plurality of sound source signals from relationships between the mixed sound signal and the separated sound source signals;
obtaining input signals of the microphone array by multiplying the estimated transfer function by the separated sound source signals; and
calculating location information of each sound source using a predetermined sound source location estimation method based on the obtained input signals.

2. The method of claim 1, wherein the separating of the sound source signals comprises: separating the sound source signals based on a condition that the sound source signals included in the mixed sound signal have statistically independent characteristics.

3. The method of claim 1, wherein the estimating of the transfer function comprises:
determining an unmixing channel separating the sound source signals from the relationships between the mixed sound signal and the separated sound source signals using a predetermined learning rule; and
estimating the transfer function by calculating an inverse of the determined unmixing channel.

4. The method of claim 3, further comprising:
removing a permutation ambiguity in which components of the unmixing channel are permutated by arranging row vectors of the unmixing channel; and
removing a scaling ambiguity in which a signal size of the unmixing channel is changed by normalizing the components of the unmixing channel using a diagonal component of the inverse of the unmixing channel.

5. The method of claim 1, wherein the calculated location information comprises at least one of a direction of each sound source and a distance between the microphone array and each sound source.

6. The method of claim 1, further comprising: improving a signal to noise ratio (SNR) of one or more sound source signals from among the sound source signals using a predetermined beam-forming algorithm based on the calculated location information.

7. A computer-readable recording medium on which a program for executing the method of claim 1 is recorded.

8. An apparatus for discriminating sound sources, the apparatus comprising:
a sound source separation unit separating sound source signals from a mixed sound signal including a plurality of sound source signals that are input through a microphone array;
a transfer function estimation unit estimating a transfer function of a mixing channel mixing the plurality of sound source signals from relationships between the mixed sound signal and the separated sound source signals;
an input signal obtaining unit obtaining input signals of the microphone array by multiplying the estimated transfer function by the separated sound source signals; and
a location information calculation unit calculating location information of each sound source using a predetermined sound source location estimation method based on the obtained input signals.

9. The apparatus of claim 8, wherein the sound source separation unit separates the sound source signals based on a condition that the sound source signals included in the mixed sound signal have statistically independent characteristics.

10. The apparatus of claim 8, wherein the transfer function estimation unit determines an unmixing channel separating the sound source signals from the relationships between the mixed sound signal and the separated sound source signals using a predetermined learning rule, and estimates the transfer function by calculating an inverse of the determined unmixing channel.

11. The apparatus of claim 10, further comprising:
a permutation ambiguity solver removing a permutation ambiguity in which components of the unmixing channel are permutated by arranging row vectors of the unmixing channel; and
a scaling ambiguity solver removing a scaling ambiguity in which a signal size of the unmixing channel is changed by normalizing the components of the unmixing channel using a diagonal component of the inverse of the unmixing channel.

12. The apparatus of claim 8, wherein the calculated location information comprises at least one of a direction of each sound source and a distance between the microphone array and each sound source.

13. The apparatus of claim 8, further comprising: a sound quality improvement unit improving an SNR of one or more sound source signals from among the sound source signals using a predetermined beam-forming algorithm based on the calculated location information.
